(19) United States
(12) Patent Application Publication
(10) Pub. No.: US 2026/0170341 A1
(43) Pub. Date: Jun. 18, 2026

(54) UNLEARNING FOR MACHINE LEARNING MODELS

(71) Applicant: Red Hat, Inc., Raleigh, NC (US)

(72) Inventors: Leigh Griffin, Waterford (IE); Dimitri Saridakis, Waterford (IE)

(21) Appl. No.: 18/980,718

(22) Filed: Dec. 13, 2024

(51) Int. Cl. G06N 3/084

(52) U.S. Cl. CPC G06N 3/084

(57) ABSTRACT

A computing system can update a parameter of a machine-learned model to reduce an effect of a training example on an activation of the machine-learned model, wherein the training example was previously used to train the machine-learned model. The computing system can provide, to the machine-learned model after updating the parameter, a test input based at least in part on the training example. The computing system can receive, from the machine-learned model, a test output based on the test input. The computing system can further update, based at least in part on the test output, the machine-learned model.

### BACKGROUND

Machine learning is a technique that can enable computing devices to learn from data. For example, a computing system can obtain a training dataset comprising a plurality of training examples, wherein each training example includes at least a training input. The computing system can provide a training input to a machine learning model; the machine learning model can generate a training output based on the training input; and the computing system can update the machine learning model based on an evaluation of the training output.

A hermetically isolated computing system is a computing system that is isolated from other computing systems, such as a computing system that is isolated for data security purposes. For example, hermetically isolated computing devices can include devices that are not connected to the Internet or any other public computing network to reduce or eliminate cybersecurity risks from such public network connections. As another example, a hermetically isolated computing network can include a network of computing devices that are locally connected to each other, but are not connected to any other network outside the hermetically isolated computing network. In some instances, a computer or network that is not connected to the Internet or other outside networks can be referred to as an “air gapped” computer or network.

### SUMMARY

The examples set forth below describe systems and methods to train machine learning models to “unlearn” previously learned training data, including systems and methods for unlearning in hermetically isolated computing systems.

In one implementation, a method is provided. The method includes updating, by a computing system comprising one or more computing devices, a parameter of a machine-learned model to reduce an effect of a training example on an activation of the machine-learned model, wherein the training example was previously used to train the machine-learned model. The method further includes providing, by the computing system to the machine-learned model after updating the parameter, a test input based at least in part on the training example. The method further includes receiving, by the computing system from the machine-learned model, a test output based on the test input. The method further includes further updating, by the computing system based at least in part on the test output, the machine-learned model.

In another implementation, a computing system is provided. The computing system includes one or more computing devices. The one or more computing devices are to update a parameter of a machine-learned model to reduce an effect of a training example on an activation of the machine-learned model, wherein the training example was previously used to train the machine-learned model. The one or more computing devices are further to provide, to the machine-learned model after updating the parameter, a test input based at least in part on the training example. The one or more computing devices are further to receive, from the machine-learned model, a test output based on the test input. The one or more computing devices are further to further update, based at least in part on the test output, the machine-learned model.

In another implementation, a non-transitory computer-readable storage medium is provided. The non-transitory computer-readable storage medium includes executable instructions to cause one or more processor devices to update a parameter of a machine-learned model to reduce an effect of a training example on an activation of the machine-learned model, wherein the training example was previously used to train the machine-learned model. The instructions further cause the one or more processor devices to provide, to the machine-learned model after updating the parameter, a test input based at least in part on the training example. The instructions further cause the one or more processor devices to receive, from the machine-learned model, a test output based on the test input. The instructions further cause the one or more processor devices to further update, based at least in part on the test output, the machine-learned model

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples disclosed herein may be practiced;

FIG. 2A is a sequence flow diagram of a method for unlearning a training example;

FIG. 2B is a sequence flow diagram of a method for unlearning a training example;

FIG. 3 is a flowchart diagram of a method for unlearning a training example;

FIG. 4 is a block diagram of an environment in which examples disclosed herein may be practiced; and

FIG. 5 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Machine learning can enable a computing system to learn from a training dataset. However, in some instances, it may be desirable to “unlearn” some information learned from a training dataset. For example, a training dataset that was used to train a machine learning model may contain outdated, inaccurate, or otherwise undesirable training examples that may cause the trained machine learning model to generate flawed outputs.

In some instances, “unlearning” can be performed by removing unwanted training examples from the original training dataset, and retraining a machine learning model from scratch. However, retraining a model from scratch can in some instances be time-consuming and expensive. For example, some large language models may cost tens of millions of dollars to train from scratch. Thus, more efficient unlearning methods are desired.

However, unlearning a single training example, without retraining the full training dataset, can be technically challenging due to interactions between related training examples. For example, during training, a single training example can cause an update to a large number of parameters of a machine learning model, and a large number of later training examples can each cause further changes to the same or different parameters. In some instances, later updates based on later training examples may be partially dependent on earlier updates associated with earlier training examples. For example, during training, a computing system may update one or more parameters of a machine learning model based on a first training example; use the updated parameters to generate a training output based on a second training example; and further update the machine learning model based on the training output. Because of these interactions, merely “reversing” a training update that was based on a training example to be unlearned may be insufficient to effectively unlearn the training example, or may cause unwanted unlearning of related training examples, or both.

In some instances, computing costs and technical challenges associated with unlearning can be particularly significant in a hermetically isolated computing environment. For example, a hermetically isolated computing environment may lack access to training resources (e.g., specialized processors such as graphics processing units, tensor processing units, etc.), testing resources (e.g., human software testers or software engineers, testing software or hardware, etc.), or other unlearning resources that an Internet-connected computing system may have access to. For example, data centers for training machine learning models can sometimes have thousands or tens of thousands of processors configured to operate in parallel, whereas a hermetically isolated device or network may have access to a much smaller number of processors. In a hermetically isolated environment, each step in an unlearning process, such as training, testing, deployment, and other steps, may need to be performed locally by the hermetically isolated system.

The examples set forth below describe various techniques for effective and efficient unlearning of training examples, including in hermetically isolated computing environments. For example, the examples set forth below describe various automated testing techniques that can be used to ensure effective unlearning. For example, a first unlearning update can be performed; an automated unlearning test can determine whether a particular training example has been successfully unlearned; and further unlearning updates can be performed if necessary. As another example, an automated functionality test can be performed after an unlearning update to determine whether the unlearning updated has caused any worsening of desired functionality; and retraining updates can be performed to recover the desired functionality. In some instances, retraining updates or further unlearning updates can include identifying related training examples that are related to the training example to be unlearned, such as training examples that were affected by the training example to be unlearned during the training process; and retraining or unlearning based on the related training examples.

The examples set forth below can provide a variety of technical effects and benefits. For example, in some instances, the examples set forth below can provide unlearning at reduced computational cost (e.g., electricity cost, memory usage, processor usage, etc.) compared to some alternative implementations, such as alternative implementations that may require extensive retraining (e.g., retraining from scratch, etc.) of a machine learning model. As another example, in some instances, the examples set forth below can provide more effective unlearning compared to some alternative implementations, such as reduced likelihood of outputting data associated with a training example to be unlearned, or improved inference accuracy associated with data that is not designated for unlearning.

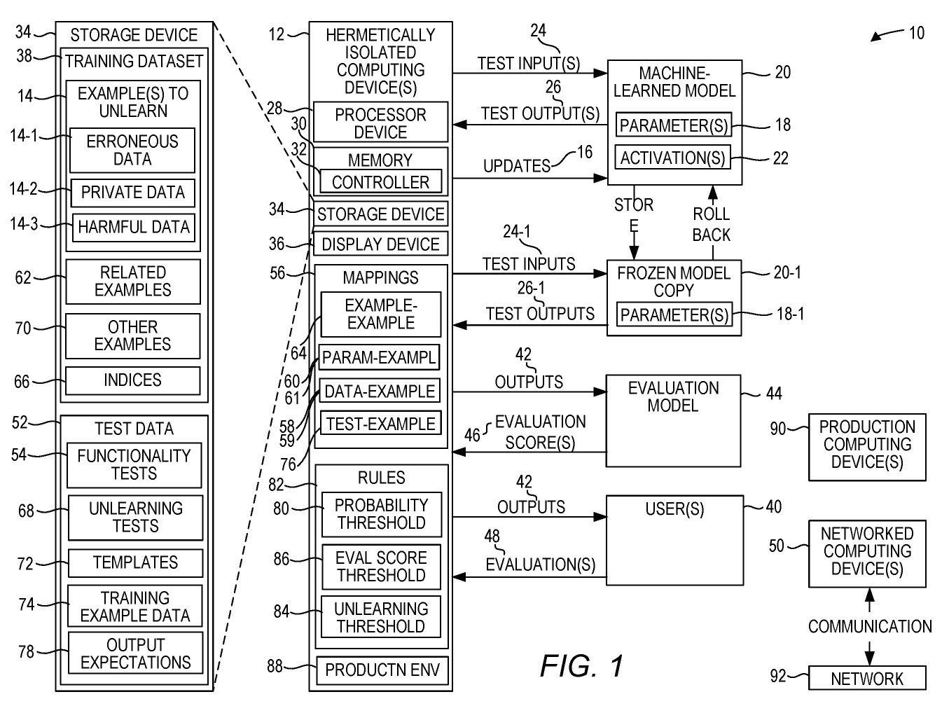

FIG. 1 is a block diagram of an environment in which examples disclosed herein may be practiced. A computing system 10 can include one or more hermetically isolated computing devices 12. Based on data indicative of a training example to unlearn 14, the hermetically isolated computing device(s) 12 can provide one or more first updates 16 to one or more parameters 18 of a machine-learned model 20 that was previously trained using the training example to unlearn 14. The first update(s) 16 can reduce an effect of the training example to unlearn 14 on one or more activations 22 of the machine-learned model 20. After providing the first update(s) 16, the hermetically isolated computing device(s) 12 can provide one or more test inputs 24 to the machine-learned model 20, and can receive one or more test outputs 26 from the machine-learned model 20 based on the test inputs 24. After receiving the test output(s) 26, the hermetically isolated computing device(s) 12 can provide one or more second updates 16 based on the test output(s) 26.

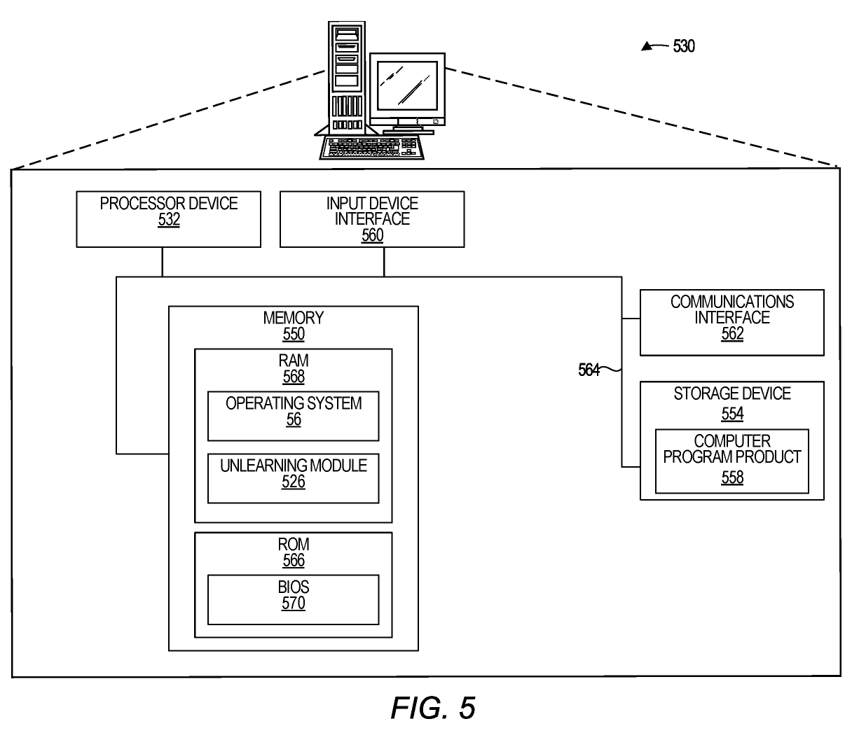

A hermetically isolated computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing system 10 can include one or more processor devices 28, memories 30 comprising a memory controller 32, storage devices 34, or display devices 36. In some instances, the hermetically isolated computing device 12 can include an air-gapped computing device that is not connected to the internet or any other public network. In some instances, the hermetically isolated computing device 12 can include a computing device that is part of a hermetically isolated (e.g., air-gapped, etc.) network, wherein no part of the hermetically isolated network is connected to the internet or another public network. Additional example implementation details for a hermetically isolated computing device 12 are provided below with respect to FIG. 5.

A training example to unlearn 14 can include, for example, a member of a training dataset 38 that was used to train the machine-learned model 20. In some instances, a training example to unlearn 14 can include one or more of erroneous data 14-1, private data 14-2, harmful data 14-3, or other data to be unlearned. Erroneous data 14-1 can include, for example, outdated data that is no longer accurate, such as time-sensitive data (e.g., current events data, time-sensitive scientific data or sensor data, etc.) that has expired (e.g., based on an expiration date, etc.) or changed for some reason. As a non-limiting illustrative example, a training example 14 may include data indicative of a current CEO of a corporation, and the data may become erroneous data 14-1 upon a change in leadership of the corporation. As another example, erroneous data 14-1 can include data that has always been erroneous, such as data that was recently discovered to be erroneous (e.g., due to new research or testing; based on a review or audit of a training dataset; etc.). Private data 14-2 can include, for example, data (e.g., private data, secure data, access-restricted data, etc.) that a computing system 10 or user 40 of the computing system is not permitted to access, such as data that the computing system 10 or user 40 is no longer permitted to access due to a change in access permissions (e.g., expiration of a data access agreement, etc.), or data that was erroneously included in a training dataset 38. For example, in some instances, private data 14-2 can include previously public or accessible data that has become the subject of a new deletion request, such as an erasure request under the European General Data Protection Regulation or the like. Harmful data 14-3 can include, for example, data that may harm an inference accuracy of a machine-learned model 20; cause a machine-learned model 20 to output potentially harmful outputs (e.g., inaccurate outputs that may be harmful if relied on in an industrial process or for some other purpose, accurate outputs that may be misused by an untrusted user, etc.); or otherwise cause a machine-learned model 20 to output less desirable outputs compared to a similar machine-learned model that has not been trained using the harmful data 14-3.

A hermetically isolated computing device 12 can obtain data indicative of one or more training examples to be unlearned 14 in any appropriate manner. In some instances, obtaining data indicative of a training example to be unlearned 14 can include receiving an unlearning request indicative of the training example to be unlearned 14, such as an unlearning request received from a user 40 or another computing device. In some instances, an unlearning request can include or not include data expressly identifying the training example to be unlearned 14, such as a numerical training example identifier. In some instances, an unlearning request may contain other data indicative of the training example to be unlearned 14. For example, in some instances, a hermetically isolated computing device 12 can receive provide outputs 42 of a machine-learned model 20 to a user 40 or machine-learned output evaluation model 44, and can receive evaluations 46, 48 (e.g., evaluations scores, thumbs up/thumbs down evaluations, feedback in a natural language such as English, etc.) indicative of a quality of the outputs 42. In such instances, an evaluation 46, 48 indicative of a low-quality or erroneous output 42 can be used to identify a training example to be unlearned 14. For example, in some instances, the evaluation 46, 48 may include data indicating which portion of the output 42 is erroneous or otherwise flawed, and the hermetically isolated computing device 12 can determine which portions of the training dataset 38 influenced the flawed portion of the output 42. Further details of some example implementations of evaluation models 44; evaluations 46, 48; and methods for mapping relationships between output 42 portions and corresponding training dataset 38 portions that influenced the output 42 portions are provided below.

Although FIG. 1 depicts actions being performed by a hermetically isolated computing device 12, other computing devices can perform the described functions without deviating from the scope of the present disclosure. For example, in some instances, a networked computing device 50 can perform any action described herein without deviating from the scope of the present disclosure.

In some instances, obtaining data indicative of a training example to be unlearned 14 can include performing testing (e.g., periodic testing, testing after each of a plurality of training updates, etc.), and identifying training examples to be unlearned 14 based on the testing. As an example, in some instances, a computing device 12, 50 can store test data 52 comprising a plurality of functionality tests 54. In some instances, a computing device 12, 50 can regularly (e.g., periodically, each time a machine-learned model 20 is updated, etc.) execute the functionality tests 54. The computing device 12, 50 can determine, based on results of the functionality tests 54, whether any functionality of the machine-learned model 20 has deteriorated.

For example, in some instances, a machine-learned model 20 or training dataset 38 can be continually (e.g., regularly or irregularly, on an ongoing basis, etc.) updated with new training examples. As a non-limiting illustrative example, a networked computing device 50 may regularly obtain news data (e.g., using an application programming interface provided by one or more news providers, etc.) and add the data to the training dataset 38. Continuing the non-limiting illustrative example, the news data can be periodically (e.g., regularly or irregularly) provided to a hermetically isolated computing device 12 (e.g., via a USB drive, external hard disk drive, or other non-transitory computer readable storage media from which the hermetically isolated computing device 12 can access the news data). As another example, one or more users 40 of a hermetically isolated computing system can provide input data to a hermetically isolated computing device 12, and the input data can be used to further train the machine-learned model 20 over time. In such instances, stored functionality tests 54 can be regularly performed to identify areas in which model performance may have deteriorated. Further details of some example methods for comparing before-and-after functionality test 54 results of a machine-learned model 20 before and after updating are provided below.

In some instances, if a performance of the machine-learned model 20 on one or more functionality tests 54 has deteriorated (e.g., below a target performance threshold, etc.), then a hermetically isolated computing device 12 can identify one or more training examples to be unlearned 14 based on the functionality tests 54. For example, the hermetically isolated computing device 12 can determine, based on the functionality tests 54, one or more erroneous or low-quality portions of a machine-learned model 20 output; determine, based on mapping 56 data, one or more related training examples of the training dataset 38 that influenced the low-quality portion(s); and determine, based on the related training examples, one or more training examples to be unlearned 14.

For example, in some instances, mapping 56 data stored by a hermetically isolated computing device 12 can include a data-to-training example mapping data structure 58 comprising a plurality of data-to-training-example mappings 59. Each data-to-training-example mapping 59 can be, for example, a data entry correlating one or more training examples of the training dataset 38 with one or more corresponding data items associated with the training examples, such as data contained in the corresponding training example; data that is more likely to be output by the machine-learned model 20 after being updated based on the training example; or other data. As a non-limiting illustrative example, a data-to-training-example mapping 59 can include a data entry correlating a training example with a machine-learned embedding of data contained in all or part of the training example, such as a sentence embedding of a natural language sentence contained in the training example. Continuing the non-limiting illustrative example, identifying a training example to be unlearned 14 can include, for example, generating a machine-learned embedding of all or part of a flawed functionality test 54 output; and retrieving, from a data-to-training-example mapping data structure 58, one or more training examples to be unlearned 14 based on the embedding. For example, in some instances, a hermetically isolated computing device 12 can retrieve k data entries (where k can be a positive integer) having the k most similar embeddings to the embedding of the flawed functionality test 54 output according to a metric of similarity (e.g., cosine distance, Euclidean distance, etc.).

As another example, mapping 56 data stored by a hermetically isolated computing device 12 can include a parameter-to-training-example mapping data structure 60 comprising a plurality of parameter-to-training-example mappings 61. Each parameter-to-training-example mapping 61 can be, for example, a data entry correlating a training example of the training dataset 38 with a corresponding set of one or more parameters 18 of the machine-learned model 20 that were influenced by the training example during an initial training of the machine-learned model 20. In some instances, a hermetically isolated computing device 12 can identify, based on one or more activations 22 of the machine-learned model 20 during performance of a functionality test 54, one or more parameters 18 that contributed significantly to a flawed functionality test 54 output. In some instances, the hermetically isolated computing device 12 can retrieve, from the parameter-to-training-example mapping data structure 60, one or more parameter-to-training-example mappings 61 associated with the parameters 18 that contributed significantly to the flawed functionality test 54 output. For example, in some instances, a hermetically isolated computing device 12 can retrieve k data entries (where k can be a positive integer) having parameter values that are most similar to parameter values of the parameters 18 that contributed to the flawed functionality test 54 output according to a similarity metric (e.g., cosine distance, dot product magnitude, Jaccard index, etc.), and training examples to be unlearned 14 can be selected based on the data entries.

In some instances, mapping 56 data can be obtained in any appropriate manner, such as by receiving mapping 56 data (e.g., from a computing device 12, 50 that initially trained the machine-learned model 20), generating the mapping 56 data, or otherwise obtaining the mapping 56 data. Further details of some example implementations for generating mapping 56 data are provided below.

In some instances, obtaining data indicative of a training example to be unlearned 14 can include retrieving data indicative of the training example to be unlearned 14. For example, in some instances, a training dataset 38 can include one or more training examples having an associated expiration date, such as training examples comprising current events data (e.g., current identity of a U.S. president scheduled to leave office on a particular date, etc.), temporal data (e.g., data describing “the weather today,” etc.), or other data having an associated expiration time. In some instances, determining a training example to be unlearned 14 can include comparing a current date or time to one or more expiration dates or times associated with the training dataset 38. As another example, in some instances, a training dataset 38 can include one or more training examples comprising factual data that may change in the future. In some instances, a hermetically isolated computing device 12 may obtain (e.g., from a user 40, from non-transitory computer readable media comprising the data such as an external hard disk drive or solid state drive, etc.) updated data indicating that the factual data has changed. In such instances, one or more training examples comprising superseded or obsolete data can be identified as training examples to be unlearned 14. Other methods of obtaining data indicative of training examples to be unlearned 14 are possible.

Based on the training example(s) to be unlearned 14, the computing system can provide one or more initial unlearning updates 16 to the machine-learned model. An update 16 can include, for example, one or more values (e.g., numerical values, etc.) for updating one or more parameters 18 of the machine-learned model 20. For example, in some instances, an update 16 can include a plurality of respective numerical adjustment values for adjusting a plurality of respective parameters, such as an adjustment value to be added to a current parameter value, or an adjustment value for another adjustment operation (e.g., subtraction, multiplication, division, etc.). In some instances, an update 16 can be determined by providing a training example to be unlearned 14 to the machine-learned model 20; generating, by the machine-learned model 20, an inference output based on the training example to be unlearned 14; receiving, by the hermetically isolated computing device 12, the inference output; and determining, by the hermetically isolated computing device 12, the update 16 based on the inference output. In some instances, determining an update 16 can include evaluating the inference output based on a comparison between the inference output and the example to be unlearned 14, and determining the update 16 based on the evaluation. For example, in some instances, an inference operation can be evaluated based on a loss function that penalizes inference outputs indicative of information learned from the training example to be unlearned 14, and determining an update 16 can include backpropagating based on the loss function. In some instances, an update 16 can include an update 16 to one or more parameters 18 to reduce an effect of the training example to be unlearned 14 on one or more activations 22 of the machine-learned model 20.

In some instances, a hermetically isolated computing device 12 can store training history data (e.g., training log data, update history data, hyperparameter history data for training hyperparameters such as learning rate, Adam optimization parameters, batch size, etc.), and an update 16 can be determined based at least in part on the stored training history. For example, in some instances, an update 16 can be determined based on a loss function and a learning rate hyperparameter, such as a learning rate hyperparameter that was used to train the machine-learned model 20 using the training example to be unlearned 14 during an initial training process. As another example, in some instances, a hermetically isolated computing device 12 can store data indicative of one or more past updates (e.g., numerical update values) provided to the machine-learned model 20 during an initial training process, and an unlearning update 16 can be determined based at least in part on the past update(s). For example, in some instances, an update 16 can include an update 16 to roll back (e.g., undo, reverse, etc.) updates determined based on the training example to be unlearned 14 during an initial training process. Other implementations are possible.

In some instances, initial unlearning updates 16 can include updates 16 determined based on related training examples 62 that are related to the training example to be unlearned 14. Related training examples 62 can include, for example, training examples that were used to train the machine-learned model 20 during an initial training process. Related training examples 62 can be related to the training example to be unlearned 14 in various ways, such as by containing similar or related data; being associated with similar or related parameters 18 or activations 22 (e.g., having been used to update similar or related parameters 18 during an initial training process, etc.); being within a “blast radius” of the training example to be unlearned 14, wherein outputs of the machine-learned model 20 generated based on the related examples 62 are influenced at least in part by training updates associated with the training example to be unlearned 14; or other relationship. Related examples 62 can be determined, for example, by retrieving data indicative of the related examples 62 from one or more mapping 56 data structures, such as an example-example mapping data structure 64, a parameter-example mapping data structure 60, or a data-example mapping data structure 58; or from one or more indices 66. In some instances, an unlearning update 16 based on a related example 62 can be performed in any manner described herein with respect to an unlearning update 16 based on a training example to be unlearned 14 (e.g., backpropagation based on a loss function that penalizes outputting data learned from the related example 42, etc.). Further details of example methods for determining related training examples 62 and performing unlearning updates based on the related training examples 62 are provided below. For example, any method described below with respect to unlearning based on related training examples 62 after one or more unlearning tests 68 can, additionally or alternatively, be performed as an initial unlearning operation (e.g., before any unlearning tests 68 are performed.)

A parameter 18 can include any parameter of a machine-learned model 20, such as one or more weights of a neural network; query weight matrix or key weight matrix of a machine-learned attention layer; or other parameter. In some instances, a parameter 18 can include one or more numerical values (e.g., weights, etc.) that are used to process inputs and generate outputs, such as weights that are multiplied by input values (e.g., using matrix multiplication, etc.) or other activations 22 as part of an inference process.

A machine-learned model 20 can include, for example, a trained machine learning model that has been trained using the training dataset 38. In some instances, a machine-learned model 20 can include various machine learning architectures, such as neural networks (e.g., convolutional neural networks, transformers, recurrent neural networks, etc.), sequence processing models (e.g., transformers, selective structured state space machines, etc.), or other machine learning architectures (e.g., random forests, state machines, etc.). In some instances, a machine-learned model 20 can include a machine-learned model 20 configured to process language inputs (e.g., natural language inputs, computer programming language inputs, etc.) or generate language outputs. In some instances, a machine-learned model 20 can include a multimodal model (e.g., text and image, audio and image, etc.) configured to input or output a plurality of datatypes, or a unimodal model to input and output one data type. In some instances, a machine-learned model 20 can include a large language model, such as a language model having more than one billion parameters 18 (e.g., more than ten billion, more than 100 billion, more than 300 billion, etc.).

An activation 22 can include, for example, an input activation value that is input to a machine-learned model 20 (e.g., input to one or more nodes of a neural network, etc.), an output activation value that is output by a portion of the machine-learned model 20 (e.g., by one or more nodes of an input layer or hidden layer of a neural network machine-learned model 20, etc.), or the like. In some instances, an activation 22 can include one or more numerical values determined by the machine-learned model 20 or component thereof (e.g., node of a neural network, etc.) based on one or more inputs (e.g., input associated with a training example to be unlearned 14, related example 62, or other example 70; input that is not associated with a training example, such as an input received from a user 40; input activation received from another node of the machine-learned model 20; etc.). For example, in some instances, an activation 22 can include an output of a component (e.g., neural network node, etc.) of the machine-learned model 20 based on one or more inputs to the component. For example, in some instances, a machine-learned model 20 can include one or more nodes configured to receive first activations 22 as inputs; process the first activations 22 based on one or more parameters 18 (e.g., multiply the first activations 22 by one or more weights using matrix multiplication, etc.) to generate a first result; and process the first result using an activation function (e.g., sigmoid activation function, rectified linear unit, etc.) to generate one or more output activations 22.

A test input 24 can include, for example, any data configured to be provided to the machine-learned model 20 as input. A test input 24 can include one type or multiple types of data. Example data types for a test input 24 can include text data, numerical data, image data, audio data, video data, multimodal input types (e.g., text and audio, etc.); language data types (e.g., natural language data, computing language data, etc.; text-based language data, audio speech data, video- or image-based language data, etc.); or other data types (e.g., imaging data, sensor data, etc.). In some instances, a test input 24 can include data of a type that is the same as or different from data of a training dataset 38 or training example to be unlearned 14. In some instances, test inputs 24 can include test inputs 24 associated with one or more functionality tests 54; unlearning tests 68; or other tests.

Test inputs 24 can be obtained in various ways, such as by retrieving the test inputs 24 (e.g., from a test data 52 data structure, etc.); generating the test inputs 24 (e.g., based on test templates 72, based on training examples to unlearn 14 or other training example data 74, etc.); receiving the test inputs 24 (e.g., from a user, from another computing device, etc.); or otherwise obtaining the test inputs 24.

In some instances, a hermetically isolated computing device 12 can determine the test inputs 24 by retrieving, from a data structure comprising test data 52, one or more tests 54, 68 comprising the test inputs 24, and can provide the test inputs 24 to the machine-learned model 20. In some instances, tests 54, 68 can be retrieved based at least in part on a training example to be unlearned 14 or related examples 62; one or more mappings 56; or other data. For example, in some instances, a hermetically isolated computing device 12 can retrieve, from a data structure 76 mapping training examples 14, 62, 70 to corresponding tests 54, 68, one or more unlearning tests 68 associated with a training example to be unlearned 14; and provide, to the machine-learned model 20 based on the unlearning test(s) 68, an unlearning test input 24 associated with the unlearning test(s) 68. As another example, in some instances, a hermetically isolated computing device 12 can retrieve, from a mapping data structure 56, a data entry correlating a training example to be unlearned 14 to related parameters 18, related training examples 62, related data learned from the training example to be unlearned 14, or other data; and determine (e.g., generate, retrieve, etc.) a test input 24 based on the data entry. In some instances, a test input 24 can be included in a retrieved mapping 56 data entry or test 54, 68, or can be generated based on a retrieved data entry or test 54, 68 (e.g., according to methods described below, etc.).

In some instances, tests 54, 68 or related examples 62 can be retrieved based on one or more indices (e.g., database index, keyword index, embedding index, vector index, etc.). For example, in some instances, tests 54, 68 or related examples 62 can be retrieved from a data structure based on a metric of similarity (e.g., metric of difference, etc.) between the tests 54, 68 or related examples 62 and data contained in the training example to be unlearned 14. Metrics of similarity can include, for example, edit distance (e.g., edit distance between a first telephone number contained in a training example to be unlearned 14 and a second telephone number contained in a related training example 62, etc.), semantic distance (e.g., cosine distance or Euclidean distance between machine-learned embeddings of data associated with the training example to be unlearned 14 and data associated with a test 54, 68 or related example 62, etc.), keyword matching metric (e.g., “best match 25” (BM25) metric, etc.), or other similarity metric. In some instances, retrieving similar tests 54, 68 or related examples 62 can include retrieving from an indexed data structure based on an index associated with the similarity metric.

In some instances, a hermetically isolated computing device 12 can determine the test inputs 24 by generating the test inputs 24 (e.g., based on the training example to be unlearned 14 or data 14-1, 14-2, 14-3 contained therein; based on a test template 72; etc.). For example, in some instances, a hermetically isolated computing device 12 can retrieve, from a test template 72 data structure, one or more test input templates; and combine the test input template(s) with data contained in a training example 14, 62, 70 to generate a test input 24. As another example, in some instances, a hermetically isolated computing device 12 can provide, to the machine-learned model 20 or a different machine-learned model (e.g., language model, etc.), a training example 14, 62, 70, along with in-context learning content to cause the machine-learned model to output a test input 24 associated with the training example 14, 62, 70. In-context learning content can include, for example, instruction content; few-shot prompt content comprising example input-output pairs; chain-of-thought prompt content comprising one or more example reasoning-output pairs or input-reasoning-output tuples; or other in-context learning content. The machine-learned model can then generate, based on the training example 14, 62, 70 and in-context learning content, a test input 24. Other implementations are possible.

In some instances, a test input 24 can include a test input associated with an unlearning test 68. An unlearning test 68 can include, for example, a test to determine whether the machine-learned model 20 has successfully unlearned data associated with a training example to be unlearned 14. For example, in some instances, an unlearning test 68 can include a test input 24 configured to cause the machine-learned model 20 to output data contained in or otherwise learned from the training example to be unlearned 14. As a non-limiting illustrative example, a training example to be unlearned 14 may contain erroneous data 14-1 that is outdated, such as “Current year: 2023,” and a test input 24 can include in-context learning content to cause the machine-learned model 20 to output the erroneous data 14-1, such as “Current year:”, “What year is it today?”, or the like. An unlearning test 68 can include, for example, a test input 24 to cause the machine-learned model 20 to output data (e.g., erroneous data 14-1, private data 14-2, harmful data 14-3, etc.) contained in a training example to be unlearned 14 or otherwise indicative of learning from the training example to be unlearned 14; receiving, from the machine-learned model 20, an inference output generated by the machine-learned model 20 based on the test input; and determining, based on the inference output, whether the machine-learned model 20 has successfully unlearned the training example to be unlearned 14.

In some instances, determining whether a machine-learned model 20 has successfully unlearned a training example to be unlearned 14 can include comparing an inference output generated by the machine-learned model 20 based on a test input 24 to one or more of: an output expectation 78 associated with an unlearning test 68; a training example to be unlearned 14; data (e.g., erroneous data 14-1, private data 14-2, harmful data 14-3, etc.) contained in or otherwise associated with a training example to be unlearned; or other relevant comparison. For example, in some instances, determining whether a machine-learned model 20 has successfully unlearned a training example to be unlearned 14 can include determining, responsive to receiving an inference output comprising data (erroneous data 14-1, private data 14-2, harmful data 14-3, etc.) contained in or otherwise associated with a training example to be unlearned, that additional unlearning is to be done; and determining, responsive to receiving an inference output that does not comprise data (erroneous data 14-1, private data 14-2, harmful data 14-3, etc.) contained in or otherwise associated with a training example to be unlearned, that the machine-learned model 20 has successfully unlearned a training example to be unlearned 14.

In some instances, an inference output can include a probability distribution (e.g., softmax probability distribution, etc.) or other probability data, such as an output probability distribution output by one or more embedding layers of a machine-learned model 20. As a non-limiting illustrative example, in some instances, a machine-learned model 20 can include an autoregressive sequence generation architecture (e.g., language model architecture, transformer architecture, etc.) configured to generate an output sequence using autoregressive token sampling based on a probability distribution (e.g., softmax probability distribution) of token probabilities associated with a token vocabulary of the machine-learned model 20. In such instances, an inference output can include a distribution of token probabilities from which an output token is sampled. In some instances, determining whether a machine-learned model 20 has successfully unlearned a training example to be unlearned 14 can include comparing, by the hermetically isolated computing device 12, one or more probabilities of an inference output comprising a probability distribution to one or more corresponding probability thresholds 80. A probability threshold 80 can include, for example, a rule 82 defining a maximum acceptable probability of generating, by the machine-learned model 20, an output indicative of data learned from the training example to be unlearned 14 based on one or more test inputs 24. In some instances, a rule 82 can include another unlearning threshold 84, such as a similarity threshold indicative of a maximum similarity metric (e.g., cosine distance of machine-learned embeddings, etc.) between a training example to be unlearned 14 and a corresponding test output 26, or other unlearning threshold 84.

In some instances, a hermetically isolated computing device can provide one or more further updates 16 to the machine-learned model 20 responsive to an unlearning test 68 indicating that the machine-learned model 20 has not successfully unlearned the training example to be unlearned 14. In some instances, a further update 16 can include a further update 16 based on the training example to be unlearned 14; a further update 16 based on one or more related examples 62; or other update 16. For example, in some instances, a further update 16 can include an update 16 to magnify an effect of a first update 16, such as a duplicate copy of the first update 16 or an update 16 that is directed to some or all of the same parameters 18 as the first update 16. In some instances, determining a further update 16 can include providing the training example to be unlearned 14 to the machine-learned model 20; receiving an inference output from the machine-learned model 20 based on the training example to be unlearned 14; evaluating a loss function based on the inference output; and backpropagating based on the loss function (e.g., as described above). In some instances, a further update 16 can include an update 16 based on one or more related examples 62 that are related to the example to be unlearned 14, such as related examples 62 retrieved from a mapping data structure 56, related examples 62 identified based on one or more unlearning tests 68, or other related examples 62. In some instances, determining a further update 16 can include providing an input comprising the related example 62 to the machine-learned model 20; receiving, from the machine-learned model 20, an inference output generated by the machine-learned model 20 based on the input; and determining an update 16 based on an evaluation of the inference output (e.g., by backpropagating a loss function that penalizes inference outputs comprising data to be unlearned, etc.).

In some instances, unlearning tests 68 or further updates 16 can include unlearning tests 68 or further updates determined (e.g., generated, retrieved, etc.) based at least in part on related examples 62 that are related to the training example to be unlearned 14. For example, in some instances, an unlearning test 68 can include a test input 24 comprising data contained in a related training example 62 (e.g., in combination with a test template 72, etc.). A hermetically isolated computing device 12 can provide the test input 24 to the machine-learned model 20, receive a test output 26 based on the test input 24, and can determine whether the test output 26 is indicative of information learned from the training example to be unlearned 14. As another example, in some instances, a hermetically isolated computing device 12 can determine, based on a related training example 62 and responsive to determining that the machine-learned model 20 has failed an unlearning test 68 (e.g., unlearning test 68 associated with or not associated with the related training example 62, etc.), an update 16 to further reduce an effect of the training example to be unlearned 14 or related training example 62 on one or more activations 22 of the machine-learned model.

In some instances, related training examples 62 can be determined based on one or more mapping data structures 56; based on a comparison between parameters 18 or activations 22 associated with the training example to be unlearned 14 and related training example 62; based on a metric of similarity between the training example to be unlearned 14 and the related training example 62; or the like.

In some instances, a hermetically sealed computing device 12 can generate mapping data during an initial training process of the machine-learned model 20, or receive one or more mapping data structures 56 from another computing device that generated the mapping data during the initial training process. For example, in some instances, initial training can include providing an input associated with a training example 14, 62, 70 to the machine-learned model 20; generating, by the machine-learned model 20, an inference output based on the training example 14, 62, 70; and updating, by a computing system, update the machine-learned model 20 based on the inference output. In some instances, generating an inference output can include generating one or more activations 22, such as a plurality of zero-valued and non-zero activations 22. In some instances, updating the machine-learned model can include updating a plurality of parameters 18 of the machine-learned model 20. In such instances, a computing device associated with an initial training process can store, in a mapping data structure 56 (e.g., parameter-to-example mapping data structure 60, etc.), a data entry correlating the training example 14, 62, 70 to one or more parameters 18 updated based on the training example 14, 62, 70; a data entry correlating the training example 14, 62, 70 to one or more activations 22 generated based on the training example 14, 62, 70; a data entry correlating the training example 14, 62, 70 to another training example 14, 62, 70 associated with a similar (e.g., same, etc.) set of activations 22 or parameters 18; or other mapping data entry determined based on the training iteration.

In some instances, a hermetically sealed computing device 12 can generate mapping data (e.g., example-to-example mapping data structure 64, etc.) based on a metric of similarity between two or more training examples 14, 62, 70. For example, in some instances, a plurality of training examples 14, 62, 70 or portions thereof (e.g., data items, data fields, tokens, etc.) can be embedded by a machine-learned embedding model, and a metric of distance (e.g., cosine distance, Euclidean distance, etc.) between pairs of embedding vectors can be determined. In some instances, a distance value can be compared to a distance threshold, and pairs having a distance metric below the distance threshold can be identified as related training examples 14, 62, 70, and a data entry correlating the related training examples can be added to an example-to-example mapping data structure 64.

In some instances, further unlearning tests 68 can be performed after the further updates 16, and the process of updating and testing can be repeated until the machine-learned model 20 passes the relevant unlearning test(s) 68.

In some instances, a hermetically isolated computing device 12 can perform (e.g., subsequent to performing one or more unlearning tests 68, responsive to determining that the machine-learned model 20 has passed one or more unlearning tests 68, etc.) one or more functionality tests 54. In some instances, performing a functionality test 54 can include providing, to the machine-learned model 20, one or more test inputs 24 associated with the functionality test 54; receiving, from the machine-learned model 20, one or more test outputs 26 based on the test inputs 24; and determining, based on the test outputs 26, one or more updates 16. In some instances, determining the updates 16 can include determining the updates 16 based on an evaluation of the test outputs 26, such as by backpropagating based on an objective function (e.g., loss function, etc.) evaluated based on the test outputs 26. In some instances, an evaluation or objective function can include or be based on an evaluation score 46 (e.g., readability score, accuracy score, quality score, creativity score, etc.) received from a machine-learned evaluation model 44; an evaluation 48 received from a user 40; or other evaluation. For example, in some instances, the hermetically isolated computing device 12 can provide the test outputs 26 to one or more of a user 40 and a machine-learned evaluation model 44; receive, from the user 40 or evaluation model 44 based on the test outputs 26, one or more evaluations 46, 48; and determine, based on the evaluations 46, 48, one or more updates 16. In some instances, obtaining an evaluation score 46 from a machine-learned evaluation model 44 can include providing, to the machine-learned evaluation model 44, in-context learning content to cause the evaluation model 44 to output one or more evaluation scores 46. In-context learning content can include, for example, instruction content, few-shot prompting content, chain-of-thought prompting content, or the like. For example, in some instances, an evaluation model 44 can be provided with an instruction to generate an evaluation score (e.g., “Please rate, on a scale of one to ten, the readability of this output,” etc.); one or more example input-output pairs or input-reasoning-output tuples comprising an example input and an example evaluation score (e.g., ground truth evaluation score, human-annotated evaluation score, etc.) associated with the example input; or other in-context learning content.

In some instances, a hermetically isolated computing device 12 can evaluate one or more test outputs 26 based on a comparison to one or more output expectations. For example, in some instances, an output expectation 78 can include data indicative of a preferred test output 26, such as a known correct answer to a factual question or other output expectation 78. In some instances, a hermetically isolated computing device 12 can determine, based on an output expectation 78, that a test output 26 is acceptable or that the test output 26 is indicative of a need for further updates 16 (e.g., updates 16 determined using backpropagation of a loss function based on the output expectation 78 and test output 26, etc.).

In some instances, a hermetically isolated computing device 12 can determine, based on one or more rules 82, whether a test output 26 of the machine-learned model 20 based on a test input 24 associated with a functionality test 54 is acceptable. For example, in some instances, a rule 82 can include an evaluation score threshold 86, and a hermetically isolated computing device 12 can compare an evaluation score 46 or evaluation 48 to the evaluation score threshold 86. In some instances, a hermetically isolated computing device 12 can provide, responsive to determining that an evaluation 46, 48 does not exceed an evaluation score threshold 86, further updates 16 to the machine-learned model 20.

In some instances, functionality tests 54 or further updates 16 can be determined (e.g., generated, retrieved, etc.) based at least in part on related examples 62 that are related to the training example to be unlearned 14. For example, in some instances, a functionality test 54 can include a functionality test 54 associated with a training example 62, 70 associated with a parameter 18 that was updated by an unlearning update 16. For example, in some instances, a hermetically isolated computing device 12 can update one or more parameters 18 of the machine-learned model 20; identify, based on a parameter-to-example mapping data structure 60, one or more training examples 62, 70 associated with the parameters 18 that were updated, and obtain (e.g., generate based on test templates 72, retrieve, etc.) functionality tests 54 based on the training examples 62, 70 associated with the parameters 18.

In some instances, further updates 16 can be determined (e.g., generated, retrieved, etc.) based at least in part on related examples 62 that are related to the training example to be unlearned 14. For example, in some instances, a hermetically isolated computing device 12 can update one or more parameters 18 of the machine-learned model 20; identify, based on a parameter-to-example mapping data structure 60, one or more training examples 62, 70 associated with the parameters 18 that were updated; and perform additional training of the machine-learned model 20 based on the training examples 62, 70. For example, in some instances, the hermetically isolated computing device 12 can provide an input associated with a training example 62, 70 to the machine-learned model 20; receive an inference output based on the input; and determine, based on the inference output, an update 16. In some instances, the update 16 can be an update 16 to increase an effect of the training example 62, 70 on one or more activations of the machine-learned model 20. For example, in contrast to an unlearning update configured to reduce an effect of a training example to be unlearned 14 or other training example 62, 70 on one or more activations 22 of the machine-learned model 20 (e.g., by backpropagating a loss function that penalizes outputting data learned from the training example to be unlearned 14), a retraining update 16 based on another example 62, 70 can include an update 16 configured to increase an effect of the training example 62, 70 on one or more activations of the machine-learned model 20 (e.g., by backpropagating a loss function that rewards outputting data learned from the training example 62, 70, etc.).

In some instances, further functionality test 54 can be performed after the further updates 16, and the process of updating and testing can be repeated until the machine-learned model 20 passes the relevant functionality test(s) 54.

In some instances, responsive to determining that the machine-learned model 20 has passed one or more relevant functionality tests 54, the hermetically isolated computing device 12 can deploy the machine-learned model 20 to one or more production environments 88, 90, such as a production environment 88 of the hermetically isolated computing device 12, or a separate production computing device 90 (e.g., production server device(s), client device(s), etc.). For example, in some instances, deploying the updated machine-learned model 20 can include transmitting, by the hermetically isolated computing device 12 to one or more production computing devices 90 (e.g., plurality of client devices, etc.) via a hermetically isolated private communication network, one or more copies of the machine-learned model 20.

In some instances, the hermetically isolated computing device 12 can store one or more frozen copies 20-1 of the machine-learned model 20. For example, in some instances, the hermetically isolated computing device 12 can generate, responsive to obtaining data (e.g., unlearning requests, etc.) indicative of one or more training examples to be unlearned 14, a frozen copy 20-1 of the machine-learned model 20. As another example, in some instances, the hermetically isolated computing device 12 can periodically generate and store a plurality of frozen copies 20-1 corresponding to “checkpoints” storing states of the machine-learned model 20 at various times. As a non-limiting illustrative example, a hermetically isolated computing device 12 can train the machine-learned model 20 on an ongoing basis (e.g., daily, weekly, whenever new training examples 70 are obtained, etc.) responsive to obtaining (e.g., receiving from a user 40, retrieving from non-transitory computer-readable media such as an external drive, etc.) new training data. In such instances, the hermetically isolated computing device 12 can store one or more frozen copies 20-1 of the machine-learned model 20 corresponding to states (e.g., parameter 18 values, etc.) of the machine-learned model 20 at earlier points in the ongoing training process.

In some instances, test outputs 26 generated by an updated machine-learned model 20 can be compared to test outputs 26 generated by a frozen copy 20-1 of the machine-learned model 20. For example, in some instances, a frozen copy 20-1 of the machine-learned model 20 can be stored prior to performing one or more updates 16 based on new training examples 70 (e.g., updates 16 associated with ongoing or continual training, etc.). One or more tests (e.g., functionality tests 54, etc.) can be performed on each of the updated machine-learned model 20 and the frozen copy 20-1, and test outputs 26, 26-1 associated with the tests can be compared. For example, in some instances, test outputs 26, 26-1 associated with a functionality test 54 can be provided to a user 40 or evaluation model 44, and an evaluation 46, 48 for each of the test outputs 26, 26-1 can be obtained. Based on a comparison between the evaluations 46, 48, the hermetically isolated computing device 12 can determine whether updates 16 based on new training examples 70 have improved or impaired the functionality of the machine-learned model 20. Responsive to determining that an update 16 has harmed performance of the machine-learned model 20, the hermetically isolated computing device 12 can roll back the machine-learned model 20 to a previous state; unlearn a training example the update 16 is based on; or take another action. Rolling back a machine-learned model 20 to a previous state can include, for example, replacing an updated copy of the machine-learned model 20 with a frozen copy 20-1 corresponding to a previous state of the machine-learned model 20.

As another example, in some instances, a frozen copy 20-1 of the machine-learned model 20 can be stored prior to one or more unlearning updates 16, and test outputs 26 (e.g., output probability distributions, natural language test outputs 26, etc.) of the pre-unlearning frozen copy 20-1 and the post-unlearning machine-learned model 20 can be compared. For example, in some instances, test outputs 26, 26-1 associated with an unlearning test 68 can be compared, and the hermetically isolated computing device 12 can determine, based on a comparison between the test outputs 26, 26-1, whether an unlearning update 16 has succeeded. For example, in some instances, a first probability distribution of a test output 26 of the updated machine-learned model 20 can be compared to a second probability distribution of a test output 26-1 of the frozen copy 20-1, and the hermetically isolated computing device 12 can determine, based on a comparison (e.g., metric of difference, etc.) between the first probability distribution and the second probability distribution, whether unlearning has succeeded (e.g., according to a probability threshold, difference threshold, or other rule 82, etc.). As another example, in some instances, test outputs 26, 26-1 associated with a functionality test 54 can be compared, and the hermetically isolated computing device 12 can determine, based on a comparison between the test outputs 26, 26-1, whether an unlearning update 16 has harmed the functionality of the machine-learned model 20 (e.g., in a manner described above with respect to checkpoint frozen copies 20-1, etc.).

Although some of the examples set forth herein describe operations performed by a hermetically isolated computing device 12, hermetic isolation is not required. For example, in some instances, networked devices 50 in communication with a public network 92 can perform any operation described herein with respect to a hermetically isolated computing device 12 without deviating from the scope of the present disclosure.

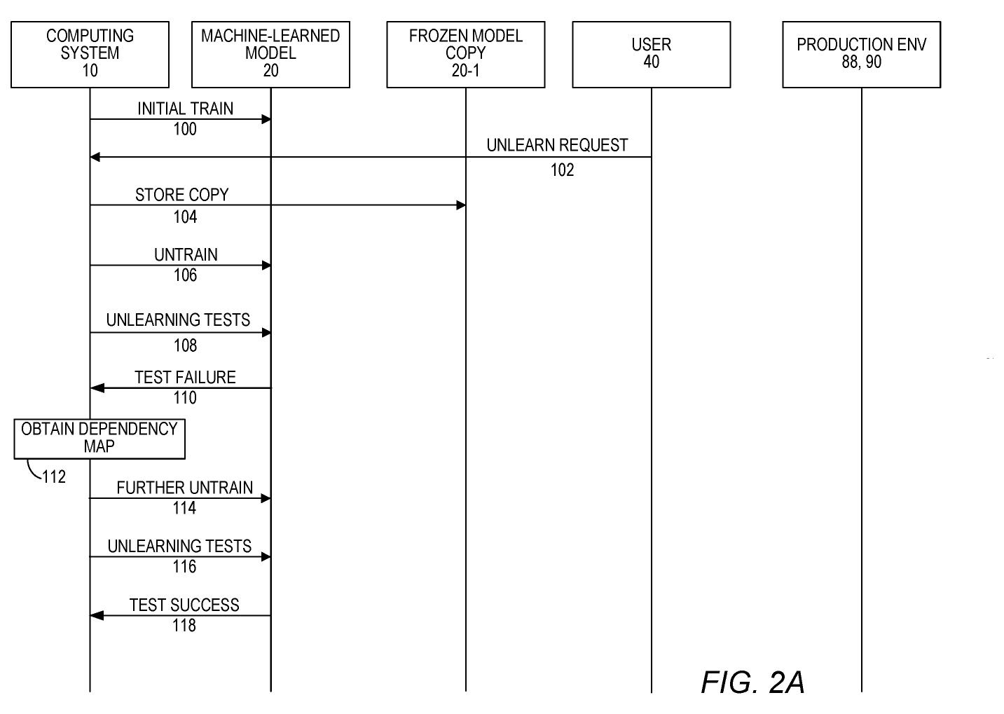

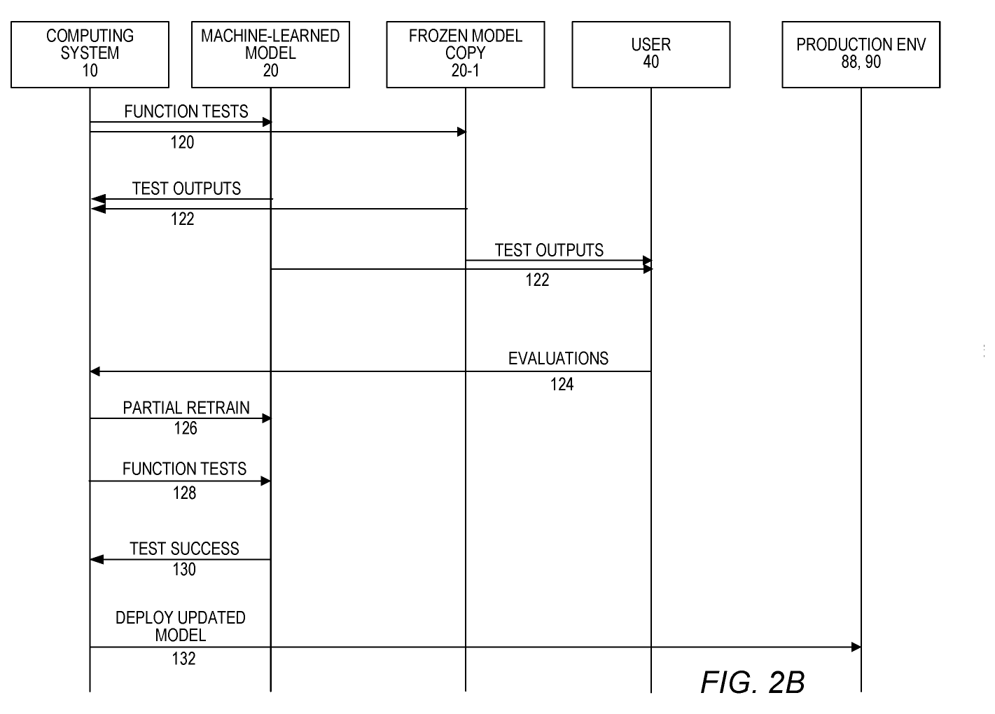

FIG. 2A is a sequence flow diagram of a method for unlearning a training example. At 100-106, the computing system 10 can receive an unlearning request and perform initial unlearning based on the unlearning request. At 108-114, the computing system 10 can perform unlearning tests and perform further unlearning based on the unlearning tests. At 116-118, the computing system 10 can perform further unlearning tests to confirm that the unlearning request has been satisfied.

At 100, a computing system 10 can initially train a machine-learned model. For example, in some instances, a computing system 10 can train a machine-learned model from scratch based on an entire training dataset 38. Other implementations are possible.

At 102, the computing system 10 can receive (e.g., from a user 40) an unlearning request identifying one or more training examples to be unlearned 14. In some instances, the computing system 10 can include multiple computing devices, which may or may not be connected to each other, and a computing device that receives the unlearning request can be the same as or different from a computing device used to perform the initial training. For example, in some instances, a networked computing device 50 can perform an initial training; a trained machine-learned model 20 can be transferred (e.g., via physical transportation of a non-transitory computer-readable storage medium, such as a solid state drive, hard disk drive, USB drive, or the like) to a hermetically isolated computing device 12; and the hermetically isolated computing device 12 can receive the unlearning request. Other implementations are possible.

At 104, the computing system 10 can store a frozen model copy 20-1. At 106, the computing system 10 can untrain the machine-learned model 20. At 108, the computing system 10 can perform one or more unlearning tests, such as by providing one or more test inputs 24 to the machine-learned model 20 and receiving one or more test outputs 26 from the machine-learned model 20. At 110, the computing system 10 can receive data indicative of a test failure associated with the one or more unlearning tests, such as data indicating that an output of the machine-learned model 20 was influenced by a training example to be unlearned 14 associated with the unlearning request.

At 112, the computing system 10 can obtain (e.g., generate, retrieve, receive, etc.) data indicative of a dependency map, such as one or more mappings 56. At 114, the computing system 10 can perform further unlearning updates based on the test failure data or based on the dependency mapping data. At 116, the computing system 10 can perform further unlearning tests, such as by providing test inputs 24 to and receiving test outputs 26 from the machine-learned model 20. At 118, the computing system 10 can receive test data indicative of successful unlearning to satisfy the unlearning request, and can perform additional actions (e.g., one or more actions described below with respect to FIG. 2B) responsive to the successful test data.

FIG. 2B is a sequence flow diagram of a method for unlearning a training example. At 120-124, the computing system 10 can perform functionality tests on a machine-learned model (e.g., a machine-learned model that has been updated according to the unlearning method of FIG. 2A, etc.). At 126, the computing system 10 can perform additional training based on the functionality tests. At 128-132, the computing system 10 can deploy the updated model perform after further testing confirms that the machine learned model is functioning satisfactorily.

At 120, the computing system 10 perform before-and-after functionality testing on the machine-learned model 20, such as by providing functionality test inputs to the machine-learned model 20 after unlearning updates and on a frozen model copy 20-1 corresponding to a state of the machine-learned model 20 before any unlearning updates are provided. At 122, the machine-learned model 20 or frozen model copy 20-1 can provide before-and-after test outputs to a user 40 or computing system 10.

At 124, a user can provide evaluation data indicative of user evaluations of the before-and-after test outputs, or a computing system 10 can perform its own evaluations (e.g., using an evaluation model 44, etc.).

At 126, a computing system 10 can partially retrain the machine-learned model 20 to correct any deterioration in functionality detected in the before-and-after testing. For example, the computing system 10 can determine, based on evaluations of the before-and-after test outputs, one or more training examples to retrain the machine-learned model 20, and can train the machine-learned model 20 (e.g., using gradient descent, etc.) based on the training examples.

At 128, the computing system 10 can provide additional functionality test inputs, which can be the same as or different from test inputs provided at 120, to the machine-learned model 20. In some instances, the computing system 10 can provide, at 128, the additional functionality test inputs to the frozen model copy 20-1 or otherwise provide the additional functionality test inputs to a machine-learned model 20 that has not been updated responsive to the unlearning request of 102.

At 130, the computing system 10 can receive test data indicative of successful performance of the retrained machine-learned model 20 on the additional functionality tests, such as test outputs having an evaluation score that exceeds an evaluation score threshold 86; test outputs that satisfy one or more output expectations 78; or the like.

At 132, the computing system 10 can deploy, responsive to receiving the successful test data, the machine-learned model 20 to a production environment, such as a production environment 88 of a computing device that performed the retraining, or a separate production computing device 90.

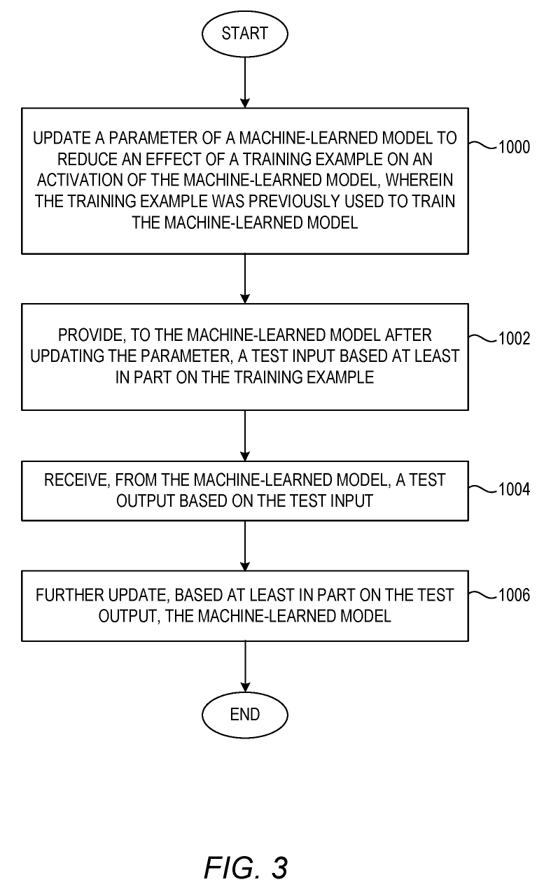

FIG. 3 is a flowchart diagram of a method for unlearning a training example. Although FIG. 3 depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

At 1000, the method of FIG. 3 can include updating (e.g., by a computing system 10, hermetically sealed computing device 12, networked computing device 50, computing device 412, etc.) a parameter (e.g., parameter 18) of a machine-learned model (e.g., machine-learned model 20) to reduce an effect of a training example (e.g., training example to unlearn 14, training example 414, etc.) on an activation (e.g., activation 22) of the machine-learned model, wherein the training example was previously used to train the machine-learned model. In some instances, the method of FIG. 3 can include, at 1000, performing one or more operations or using one or more components described above with respect to FIG. 1.

At 1002, the method of FIG. 3 can include providing (e.g., by a computing system 10, hermetically sealed computing device 12, networked computing device 50, computing device 412, etc.), to the machine-learned model after updating the parameter, a test input (e.g., test input 24, etc.) based at least in part on the training example. In some instances, the method of FIG. 3 can include, at 1002, performing one or more operations or using one or more components described above with respect to FIG. 1.

At 1004, the method of FIG. 3 can include receiving (e.g., by a computing system 10, hermetically sealed computing device 12, networked computing device 50, computing device 412, etc.), from the machine-learned model, a test output (e.g., test output 26, etc.) based on the test input. In some instances, the method of FIG. 3 can include, at 1004, performing one or more operations or using one or more components described above with respect to FIG. 1.

At 1006, the method of FIG. 3 can include further updating (e.g., by a computing system 10, hermetically sealed computing device 12, networked computing device 50, computing device 412, etc.), based at least in part on the test output, the machine-learned model. In some instances, the method of FIG. 3 can include, at 1006, performing one or more operations or using one or more components described above with respect to FIG. 1.

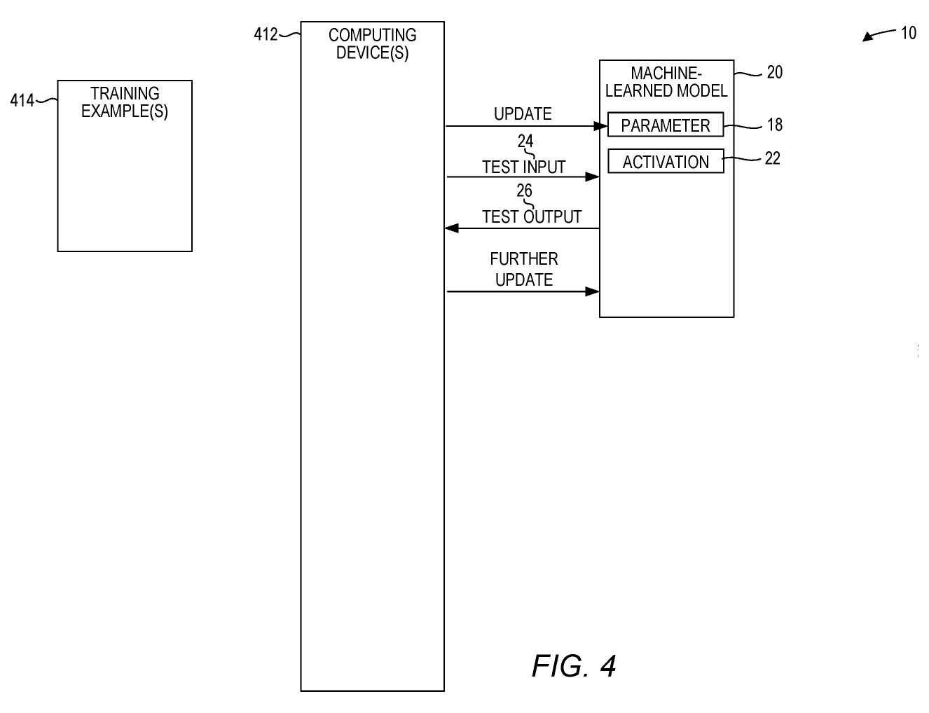

FIG. 4 is a block diagram of an environment in which examples disclosed herein may be practiced. One or more computing devices 412 of a computing system 10 can update a parameter 18 of a machine-learned model 20 to reduce an effect of a training example 414 on an activation 22 of the machine-learned model 20, wherein the training example 414 was previously used to train the machine-learned model 20. The one or more computing devices 412 can provide, to the machine-learned model 20 after updating the parameter 18, a test input 24 based at least in part on the training example 414. The one or more computing devices 412 can receive, from the machine-learned model 20, a test output 26 based on the test input 24. The one or more computing devices 412 can further update, based at least in part on the test output 26, the machine-learned model 20.

In some instances, a computing device 412 can be, comprise, be comprised by, or otherwise share one or more properties with a hermetically isolated computing device 12, networked computing device 50, or other computing device. For example, in some instances, a computing device 412 can have any property described herein with respect to a hermetically isolated computing device 12.

In some instances, a training example 414 can be, comprise, be comprised by, or otherwise share one or more properties with a training example to be unlearned 14, related training example 62, or other training example 70. For example, in some instances, a training example 414 can have any property described herein with respect to a training example to be unlearned 14.

FIG. 5 is a block diagram of the computing device 530 suitable for implementing examples according to one example. The computing device 530 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 530 includes the processor device 532, the system memory 550, and a system bus 564. The system bus 564 provides an interface for system components including, but not limited to, the system memory 550 and the processor device 532. The processor device 532 can be any commercially available or proprietary processor.

The system bus 564 may be any of several types of bus structures that may further interconnect to a memory bus (with or without a memory controller), a peripheral bus, and/or a local bus using any of a variety of commercially available bus architectures. The system memory 550 may include non-volatile memory 566 (e.g., read-only memory (ROM), erasable programmable read-only memory (EPROM), electrically erasable programmable read-only memory (EEPROM), etc.), and volatile memory 568 (e.g., random-access memory (RAM)). A basic input/output system (BIOS) 570 may be stored in the non-volatile memory 566 and can include the basic routines that help to transfer information between elements within the computing device 530. The volatile memory 568 may also include a high-speed RAM, such as static RAM, for caching data.

The computing device 530 may further include or be coupled to a non-transitory computer-readable storage medium such as the storage device 554, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 554 and other drives associated with computer-readable media and computer-usable media may provide non-volatile storage of data, data structures, computer-executable instructions, and the like.

A number of modules can be stored in the storage device 554 and in the volatile memory 568, including an operating system and one or more program modules, such as an unlearning module 526, which may implement the functionality described herein in whole or in part. All or a portion of the examples may be implemented as a computer program product 558 stored on a transitory or non-transitory computer-usable or computer-readable storage medium, such as the storage device 554, which includes complex programming instructions, such as complex computer-readable program code, to cause the processor device 532 to carry out the steps described herein. Thus, the computer-readable program code can comprise software instructions for implementing the functionality of the examples described herein when executed on the processor device 532. The processor device 532, in conjunction with the unlearning module 526 in the volatile memory 568, may serve as a controller, or control system, for the computing device 530 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 532 through an input device interface 560 that is coupled to the system bus 564 but can be connected by other interfaces such as a parallel port, an Institute of Electrical and Electronic Engineers (IEEE) 1394 serial port, a Universal Serial Bus (USB) port, an IR interface, and the like. The computing device 530 may also include the communications interface 562, such as an Ethernet transceiver and/or a Wi-Fi transceiver, or the like, suitable for communicating with a network as appropriate or desired. The computing device 530 may also include a video port configured to interface with a display device, to provide information to a user.

Individuals will recognize improvements and modifications to the preferred examples of the disclosure. All such improvements and modifications are considered within the scope of the concepts disclosed herein and the claims that follow.

What is claimed is:

1. A method comprising:
updating, by a computing system comprising one or more computing devices, a parameter of a machine-learned model to reduce an effect of a training example on an activation of the machine-learned model, wherein the training example was previously used to train the machine-learned model;
providing, by the computing system to the machine-learned model after updating the parameter, a test input based at least in part on the training example;
receiving, by the computing system from the machine-learned model, a test output based on the test input; and
further updating, by the computing system based at least in part on the test output, the machine-learned model.

2. The method of claim 1, wherein the parameter is a first parameter, the activation is a first activation, and the test input comprises an unlearning test input associated with the training example, and wherein further updating the machine-learned model based at least in part on the test output comprises:
further updating, by the computing system responsive to determining that the test output is indicative of first data learned from the training example, the first parameter or a second parameter to further reduce the effect of the training example on the first activation or a second activation of the machine-learned model.

3. The method of claim 2, wherein the training example is a first training example and the effect is a first effect, and wherein further updating the machine-learned model comprises:
identifying, by the computing system, a second training example associated with the first training example; and
updating, by the computing system based on the second training example, at least one of the first parameter, the second parameter, and a third parameter to reduce a second effect of the second training example on at least one of the first activation, the second activation, and a third activation of the machine-learned model.

4. The method of claim 3, wherein identifying the second training example comprises:
obtaining, by the computing system, a data structure correlating a plurality of respective training examples to a plurality of corresponding related training examples; and
retrieving, by the computing system from the data structure, a data entry correlating the first training example with the second training example.

5. The method of claim 4, wherein obtaining the data structure comprises:
obtaining, by the computing system for each respective training example of the plurality of respective training examples, data indicative of one or more non-zero activations of the machine-learned model that were generated by the machine-learned model based on the respective training example during training of the machine-learned model; and
storing, by the computing system in the data structure, based at least in part on a comparison between one or more first non-zero activations associated with the first training example and one or more second non-zero activations associated with the second training example, the data entry correlating the first training example with the second training example.

6. The method of claim 3, wherein identifying the second training example comprises:
retrieving, by the computing system from a data structure based on a metric of similarity between the first data and the second training example, data indicative of the second training example.

7. The method of claim 2, further comprising:
obtaining, by the computing system, a test input template; and
generating, by the computing system based on the test input template, the unlearning test input, wherein generating the unlearning test input comprises adding second data associated with the training example to the test input template.

8. The method of claim 2, wherein the test output comprises probability data indicative of a probability associated with the first data, and wherein further updating the machine-learned model comprises updating the machine-learned model responsive to determining that the probability exceeds a probability threshold.

9. The method of claim 1, further comprising:
obtaining, by the computing system prior to providing the test input to the machine-learned model, a data structure correlating a plurality of respective training examples to one or more of:
a plurality of corresponding related training examples;
a plurality of corresponding sets of one or more related parameters of the machine-learned model; and
a plurality of corresponding test inputs; and
determining, based at least in part on the data structure, the test input.

10. The method of claim 1, wherein the training example is a first training example and the activation is a first activation, and further comprising:
identifying, by the computing system, an additional training example associated with at least one of:
the first training example;
the parameter; and
the activation; and
updating, by the computing system based on the additional training example, the machine-learned model to increase an effect of the additional training example on at least one of: the first activation and a second activation of the machine-learned model.

11. The method of claim 10, wherein identifying the additional training example comprises:
retrieving, by the computing system, the additional training example from a data structure based on a metric of similarity between first data of the additional training example and second data of the first training example.

12. The method of claim 1, wherein the test output is a first test output, and further comprising:
providing, by the computing system, to the machine-learned model prior to updating the parameter, the test input; and
receiving, by the computing system from the machine-learned model prior to updating the parameter, a second test output based on the test input;
wherein further updating the machine-learned model comprises further updating the machine-learned model based at least in part on a metric of difference between the first test output and the second test output.

13. The method of claim 12, further comprising:
obtaining, by the computing system prior to updating the parameter, a first output probability distribution of the machine-learned model based on the test input;
obtaining, by the computing system after updating the parameter, a second output probability distribution of the machine-learned model based on the test input;
comparing, by the computing system, the first output probability distribution to the second output probability distribution; and
providing, by the computing system responsive to determining that a metric of difference between the first output probability distribution and the second output probability distribution exceeds a threshold, the first test output and the second test output to a user.

14. The method of claim 1, wherein the machine-learned model is a first machine-learned model, and further comprising:
providing, by the computing system, the test output to a second machine-learned model; and
receiving, by the computing system from the second machine-learned model, an evaluation score associated with the test output;
wherein further updating the machine-learned model comprises updating the machine-learned model based at least in part on a comparison between the evaluation score and an evaluation score threshold.

15. The method of claim 14, wherein the evaluation score comprises a readability score.

16. The method of claim 1, wherein the computing system comprises at least one air-gapped computing device that is not connected to any public network.

17. The method of claim 1, wherein updating the parameter to reduce the effect of the training example comprises backpropagating based on an objective function that penalizes the machine-learned model for outputting data associated with the training example.

18. The method of claim 1, wherein the test input is a first test input and the test output is a first test output, and further comprising:
providing, by the computing system to the machine-learned model after further updating the machine-learned model, a second test input based at least in part on the training example;
receiving, by the computing system from the machine-learned model, a second test output based on the second test input; and
deploying, by the computing system based at least in part on the second test output, the machine-learned model to a production environment.

19. A computing system comprising one or more computing devices to:
update a parameter of a machine-learned model to reduce an effect of a training example on an activation of the machine-learned model, wherein the training example was previously used to train the machine-learned model;
provide, to the machine-learned model after updating the parameter, a test input based at least in part on the training example;
receive, from the machine-learned model, a test output based on the test input; and
further update, based at least in part on the test output, the machine-learned model.

20. A non-transitory computer-readable storage medium that includes executable instructions to cause one or more processor devices to:
update a parameter of a machine-learned model to reduce an effect of a training example on an activation of the machine-learned model, wherein the training example was previously used to train the machine-learned model;
provide, to the machine-learned model after updating the parameter, a test input based at least in part on the training example;
receive, from the machine-learned model, a test output based on the test input; and
further update, based at least in part on the test output, the machine-learned model.
